(19) United States
(12) Patent Application Publication
(10) Pub. No.: US 2026/0228369 A1
(43) Pub. Date: Aug. 6, 2026

(54) SYSTEMS AND METHODS FOR ADJUSTING VEHICLE DISPLAY SCREENS

(71) Applicant: Ford Global Technologies, LLC, Dearborn, MI (US)

(72) Inventors: Keith Weston, Canton, MI (US); Brendan Diamond, Naples, FL (US)

(73) Assignee: Ford Global Technologies, LLC, Dearborn, MI (US)

(21) Appl. No.: 19/045,155

(22) Filed: Feb. 4, 2025

(51) Int. Cl. G06F 21/84; B60K 35/22; G06F 3/01

(52) U.S. Cl. CPC G06F 21/84; B60K 35/22; G06F 3/012; G06F 3/013; B60K 2360/21

(57) ABSTRACT

A vehicle including a display screen, a sensor unit and a processor is disclosed. The display screen may display a content, and the sensor unit may detect a vehicle condition and a vehicle surrounding condition. The processor may determine that the content being displayed on the display screen is of a predefined content type. The processor may further determine that the vehicle condition and/or the vehicle surrounding condition meets a predefined criterion based on inputs obtained from the sensor unit, responsive to determining that the content is of the predefined content type. The processor may additionally perform a predefined action associated with the content and/or the display screen responsive to determining that the predefined criterion is met.

### FIELD

The present disclosure relates to systems and methods for adjusting vehicle display screens while displaying sensitive content to provide privacy to vehicle occupants.

### BACKGROUND

Modern vehicles include one or more display screens that may display different types of content based on one or more vehicle occupant's requests. For example, a vehicle may include one or more front and/or rear display screens that may be used by vehicle occupants for viewing video content, navigation information, presentations or business information, accessing websites, and/or the like. There may be instances where an occupant may be viewing confidential or sensitive content on the display screen and may not prefer onlookers outside the vehicle to view such content.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example view of an interior portion of a vehicle in accordance with the present disclosure.

FIG. 2 depicts a block diagram of a system to adjust a vehicle display screen in accordance with the present disclosure.

FIG. 3 depicts an example view of a user outside a vehicle viewing a vehicle display screen in accordance with the present disclosure.

FIG. 4 depicts an example view of a user with an image capturing device outside a vehicle attempting to capture an image of a vehicle display screen in accordance with the present disclosure.

FIG. 5 depicts an example view of a second vehicle located in proximity to a first vehicle including a vehicle display screen in accordance with the present disclosure.

FIG. 6 depicts an example view of a vehicle display screen with blurred-out selective portions of a content in accordance with the present disclosure.

FIG. 7 depicts a flow diagram of an example method to adjust a vehicle display screen in accordance with the present disclosure.

### DETAILED DESCRIPTION

### Overview

The present disclosure describes a vehicle that facilitates in protecting a vehicle occupant's privacy when the occupant may be viewing sensitive content on a vehicle display screen. Examples of sensitive content include, but are not limited to, content associated with personal information, banking or financial information, confidential or secret information, business information, content having explicit language, mature content, private content, religious content, political content, cruise control set speed for the vehicle, and/or the like.

The vehicle may perform one or more predefined actions associated with the content and/or the display screen to protect the occupant's privacy, when the occupant may be viewing such content on the display screen and one or more predefined vehicle and/or its surrounding conditions are met. For example, the vehicle may blank out the display screen, stop playing the content on the display screen, redact the content on the display screen, change the content's font size or type on the display screen, change a color or brightness of a portion of the display screen displaying the content, and/or the like to protect the occupant's privacy.

In one exemplary aspect, the vehicle may perform the action(s) described above when the occupant may be viewing such content on the display screen and the vehicle speed may be less than a predefined speed threshold (e.g., 5 miles per hour). In another exemplary aspect, the vehicle may perform the action(s) described above when the occupant may be viewing such content on the display screen and one or more onlookers and/or additional vehicles may be located in proximity to a portion or side of the vehicle that includes the display screen. The vehicle may determine the presence of onlooker(s) and/or the additional vehicle(s) in proximity to the vehicle based on inputs obtained from the vehicle's sensor unit.

In some aspects, the vehicle may perform the action(s) described above when an eye or head trajectory of the onlooker(s) aligns with the display screen (indicating that the onlooker may be viewing the display screen from outside the vehicle). In further aspects, if the onlooker is carrying an image capturing device (e.g., a camera or a mobile phone), the vehicle may perform the action(s) described above when an image capturing device's field of view (FOV) aligns with the display screen (indicating that the onlooker may be attempting to capture a display screen's image by using the image capturing device).

In further aspects, the vehicle may perform the action(s) described above when the content being displayed on the display screen includes one or more predefined words or phrases, such as the word “Confidential”, “Secret” or “Sensitive”, indicating that the occupant may be viewing confidential information that may require protection from onlookers.

The present disclosure discloses a vehicle that may protect the occupant's privacy when the occupant may be viewing sensitive content on the vehicle display screen and the probability of an onlooker viewing the content from outside the vehicle may be high. The vehicle may automatically detect that the occupant may be viewing sensitive content on the display screen and then perform one or more predefined actions to protect the occupant's privacy, without requiring any manual intervention from the occupant. Further, the vehicle does not require use of any external material (e.g., shades, etc.) to hide the display screen when the occupant may be viewing sensitive content but instead uses the vehicle's existing components to protect the occupant's privacy. Therefore, the system and method disclosed in the present disclosure is simple to implement.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

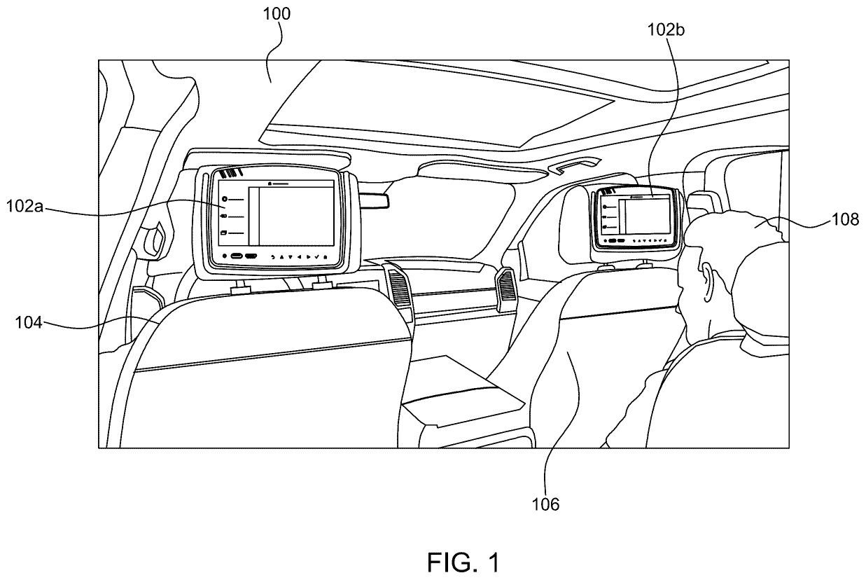

FIG. 1 depicts an example view of an interior portion of a vehicle 100 in accordance with the present disclosure. The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain, such as a gasoline engine, one or more electrically-actuated motor(s), or a hybrid system.

The vehicle 100 may include one or more display screens 102a, 102b (collectively referred to as display screen 102) that may be located at a vehicle front interior portion (to display content for vehicle's driver and front passenger) and/or a vehicle rear interior portion (to display content for vehicle's rear passenger(s)). The exemplary aspect depicted in FIG. 1 shows the display screens 102a, 102b being located on the backs of a driver sitting area 104 and a front passenger sitting area 106, respectively. However, such depiction should not be construed as limiting. The vehicle 100 may include one or more additional display screens or the display screens 102a, 102b may be located at other locations within the vehicle interior portion, without departing from the present disclosure scope.

The display screen 102 may display different types of content as per vehicle occupant's requirements. For example, a passenger or user 108 may use the display screen 102 to view video content, navigation information, financial information (bank websites/interfaces), entertainment content, explicit content, business information or presentations, personal information, and/or the like. In some aspects, the display screen 102 may be associated with a mobile office environment, a vehicle based office, a video viewing screen, and/or the like.

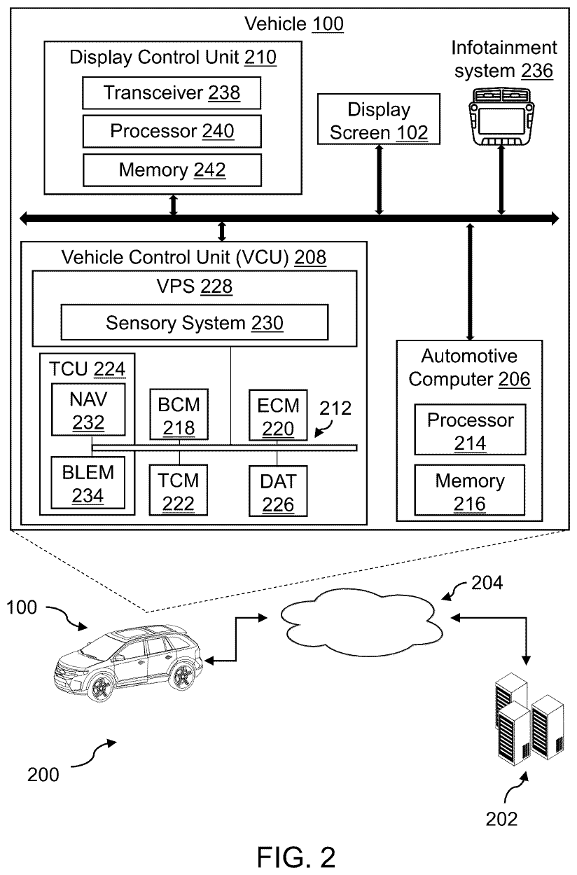

There may be instances where the user 108 may be viewing confidential or sensitive content, which the user 108 may not prefer onlookers outside the vehicle 100 to view. Examples of such content include, but are not limited to, content associated with personal information, banking or financial information, confidential or secret information, business information, content having explicit language, mature content, private content, religious content, political content, cruise control set speed for the vehicle 100, and/or the like. To protect the user's privacy in such instances, the vehicle 100 may include a display control unit (shown as display control unit 210 in FIG. 2) that may perform a predefined action on the content being displayed on the display screen 102 and/or the display screen 102 itself when the user 108 may be viewing such content on the display screen 102 and one or more predefined criteria may be met. For example, the display control unit (“unit”) may blank out the display screen 102, stop playing the content on the display screen 102, redact the content on the display screen 102, change a font size or a font type associated with the content, change a color and/or a brightness of a portion of the display screen 102 displaying the content, and/or the like whenever the user 108 may be viewing such content on the display screen 102 and one or more predefined criteria may be met. Examples of the predefined criteria are described briefly below and described in detail later in conjunction with FIG. 2.

In one exemplary aspect, the unit may perform the predefined action(s) described above when the user 108 may be viewing such content on the display screen 102 and the vehicle speed may be less than a predefined speed threshold (e.g., 5 miles per hour). In this case, the unit may enable the display screen 102 to display the content in a normal manner when the vehicle speed may be greater than 5 miles per hour and may redact or blur-out the content on the display screen 102 when the vehicle speed drops below 5 miles per hour.

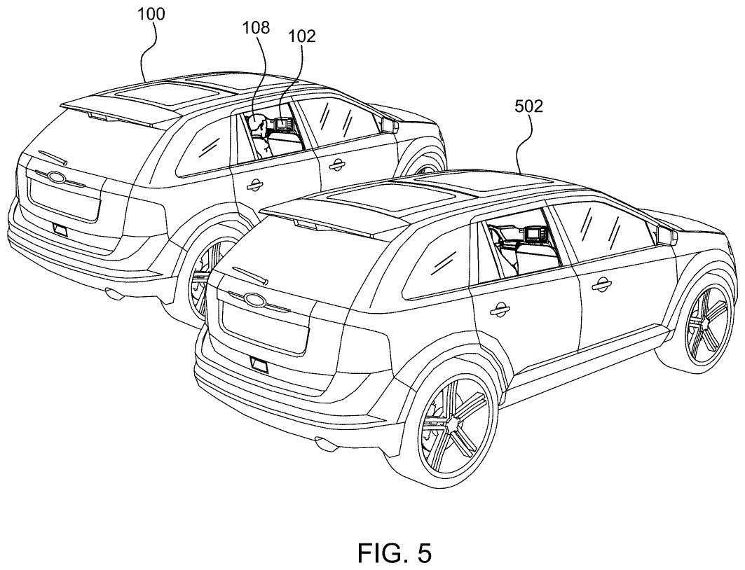

In another exemplary aspect, the unit may perform the predefined action(s) described above when the user 108 may be viewing such content on the display screen 102 and one or more additional vehicles (e.g., a second vehicle 502 shown in FIG. 5) may be located in proximity to the vehicle 100. In some aspects, in this case, the unit may perform the predefined action(s) when the additional vehicle(s) may be located in proximity to that side or portion of the vehicle 100 that includes the display screen 102 on which the user 108 may be watching the content. For example, if the display screen 102 on which the user 108 may be watching the content is located on the vehicle's rear right side and the additional vehicle is also located in proximity to the vehicle's right side, the unit may perform the predefined action(s) described above. On the other hand, the unit may enable the display screen 102 to continue displaying the content in the normal manner if the additional vehicle is located in proximity to the vehicle's left side (as the content being displayed on the display screen 102 may not be visible to the occupants of the additional vehicle in this case).

In yet another exemplary aspect, the unit may perform the predefined action(s) described above when the user 108 may be viewing such content on the display screen 102 and one or more onlookers or “second users” may be present outside the vehicle 100, in proximity to that side or portion of the vehicle 100 that includes the display screen 102. In this case, the unit may check whether an onlooker's eye or head trajectory aligns with the display screen 102 and may perform the predefined action(s) described above when the eye or head trajectory aligns with the display screen 102.

In additional aspects, the unit may check whether the onlooker is carrying any image capturing device (e.g., a camera, a mobile phone, etc.) based on inputs obtained from a vehicle's sensor unit. The unit may perform the predefined action(s) described above when the user 108 may be viewing such content on the display screen 102 and a field of view (FOV) of the onlooker's image capturing device aligns with the display screen 102 (irrespective of whether the onlooker's eye or head trajectory is aligned with the display screen 102 or not).

In this manner, the unit may protect the user's privacy by performing the predefined action(s) described above whenever the user 108 may be viewing such content on the display screen 102 and one or more onlookers and/or additional vehicles may be present in proximity to the vehicle 100/display screen 102. Further vehicle details are described below in conjunction with FIG. 2.

The vehicle 100 implements and/or performs operations, as described here in the present disclosure, in accordance with the owner manual and safety guidelines. In addition, any action taken by the user 108 based on the notifications provided by the vehicle 100 should comply with all the rules specific to the location and operation of the vehicle 100 (e.g., Federal, state, country, city, etc.). The notifications, as provided by the vehicle 100 should be treated as suggestions and only followed according to any rules specific to the location and operation of the vehicle 100.

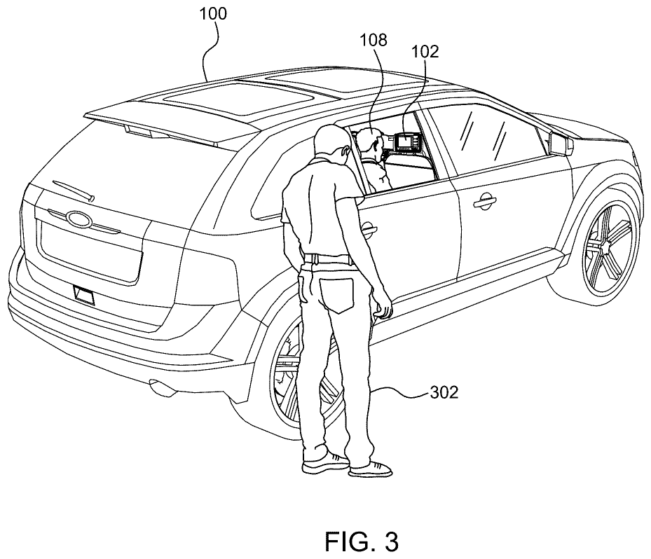

FIG. 2 depicts a block diagram of a system 200 to adjust a vehicle display screen (e.g., the display screen 102) in accordance with the present disclosure. While describing FIG. 2, references will be made to FIGS. 3, 4, 5 and 6.

The system 200 may include the vehicle 100 and one or more servers 202 (or a server 202) that may be communicatively coupled with each other via one or more networks 204. The server 202 may be part of a cloud-based computing infrastructure and may be associated with and/or include a Telematics Service Delivery Network (SDN) that provides digital data services to the vehicle 100 and other vehicles (not shown in FIG. 2) that may be part of a vehicle fleet. In further aspects, the server 202 may store information associated with predefined content types that a vehicle user (e.g., the user 108) may not prefer onlookers to view, when the user 108 may be viewing such content types on the display screen 102. Examples of predefined content types include, but are not limited to, content associated with personal information, banking or financial information, confidential or secret information, explicit language, mature content, private content, religious content, political content, cruise control set speed for the vehicle 100, and/or the like. The user 108 may “pre-configure” or transmit (e.g., via the vehicle 100 or a user device, not shown) the information associated with the predefined content types to the server 202, which the server 202 may store. Further, the server 202 may transmit this information to the vehicle 100 at a predefined frequency or when the vehicle 100 transmits a request to the server 202 to obtain such information.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 100 may include a plurality of units including, but not limited to, an automotive computer 206, a Vehicle Control Unit (VCU) 208 and a display control unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 100, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a display control program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 100 systems, connected servers (e.g., the server(s) 202), and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the vehicle 100 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a blind spot monitoring unit or sensor, a humidity sensor, a tire pressure sensor, ultrasonic sensors, etc.

In some aspects, the vehicle sensory system 230 or the VCU 208 may detect a vehicle condition and a vehicle surrounding condition. For example, the vehicle sensory system 230 may detect presence of one or more onlookers, one or more additional or second vehicles, one or more objects (e.g., mobile phones, cameras, etc.), and/or the like in proximity to the vehicle 100 (e.g., in proximity to the vehicle's exterior portion). The vehicle sensory system 230 may further detect if the content being watched by the user 108 on the display screen 102 includes one or more predefined words or phrases (e.g., the word “Confidential,” “Secret,” “Sensitive,” and/or the like). The vehicle sensory system 230 or the VCU 208 may further detect the vehicle 100 speed and/or whether the vehicle 100 may be parked or moving.

In some aspects, the VCU 208 may control vehicle operational aspects and implement one or more instruction sets received from a user device associated with a vehicle user, from one or more instruction sets stored in the memory 216, including instructions operational as part of the unit 210.

The TCU 224 may provide vehicle connectivity to wireless computing systems onboard and off board the vehicle 100 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 100 and other systems (e.g., a user device, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device associated with the vehicle user, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 100, may include a transceiver 238, a processor 240, and a computer-readable memory 242.

The transceiver 238 may receive information/inputs from one or more external devices or systems, e.g., the user device associated with the vehicle user, the server(s) 202, and/or the like via the network 204. For example, the transceiver 238 may receive the information associated with predefined content types that the user 108 may not prefer onlookers to view (as described above) from the server 202 via the network 204. Further, the transceiver 238 may transmit notifications/data/signals to the external devices or systems. In addition, the transceiver 238 may receive information/inputs from vehicle 100 components such as the infotainment system 236, the VCU 208, and/or the like. Further, the transceiver 238 may transmit notifications/command signals to the vehicle 100 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the display control program code. In some aspects, the memory 242 may store the information associated with predefined content types that the user 108 may not prefer onlookers to view, which the vehicle 100 obtains from the server 202 (or via the HMI 236 or a user device associated with the user 108).

In operation, the processor 240 may continuously (or at a predefined frequency) obtain inputs from the vehicle sensory system 230 when the user 108 may be viewing a content on the display screen 102. The processor 240 may further continuously (or at a predefined frequency) correlate the content being displayed on the display screen 102 with the information associated with predefined content types that the user 108 may not prefer onlookers to view (which may be stored in the memory 242). The processor 240 may determine that the content being displayed on the display screen 102 is of the predefined content type when the information stored in the memory 242 matches with the content.

In an exemplary aspect, to determine whether the content is of predefined content type, the processor 240 may first determine that the content being displayed on the display screen 102 includes one or more predefined words or phrases, based on the inputs (images) obtained from the vehicle sensory system 230 (e.g., interior vehicle cameras). The processor 240 may perform this step when, e.g., the content being displayed on the display screen 102 is associated with a business presentation, financial data, etc. Further, the predefined words or phrases may be pre-stored in the memory 242 as part of the information associated with predefined content types that the user 108 may not prefer onlookers to view. Responsive to determining that the content includes such predefined words or phrases, the processor 240 may determine that the content is of predefined content type. Examples of such predefined words or phrases include, but are not limited to, “Confidential,” “Secret,” “Sensitive,” “For your eyes only,” and/or the like.

In further aspects, the processor 240 may determine that the content is of predefined content type when the content is associated with personal information, banking or financial information, confidential or secret information, explicit language, mature content, private content, religious content, political content, cruise control set speed for the vehicle 100, and/or the like (determined via the inputs obtained from the vehicle sensory system 230).

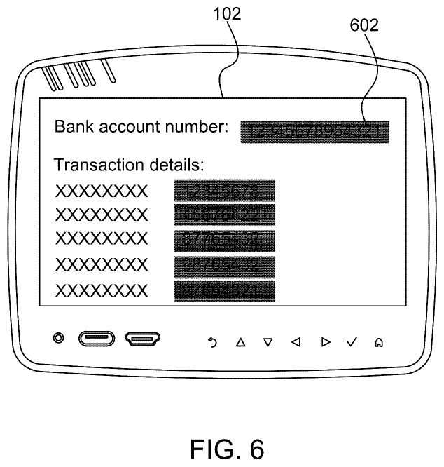

Responsive to determining that the content being displayed on the display screen 102 is of predefined content type, the processor 240 may check/determine whether a predefined criterion associated with a vehicle condition and/or a vehicle surrounding condition is met based on the inputs obtained from the vehicle sensory system 230. The processor 240 may perform one or more predefined actions associated with the content being displayed on the display screen 102 and/or the display screen 102 itself when the predefined criterion may be met, to protect the user's privacy. For example, the processor 240 may blank-out the display screen 102, stop playing the content on the display screen 102, redact the content on the display screen 102 (shown as redacted content 602 in FIG. 6), and/or the like to protect the user's privacy and prevent onlookers from viewing the content. As another example, the processor 240 may change a font size or a font type of the content being displayed on the display screen 102 and/or change a color or brightness of a portion of the display screen 102 displaying the content, to protect the user's privacy and prevent onlookers from viewing the content.

Examples of different vehicles and/or vehicle surrounding conditions that meet the predefined criterion are described below. The examples described below should not be construed as limiting.

In one exemplary aspect, the processor 240 may determine that the predefined criterion associated with the vehicle condition is met when the vehicle speed may be less than a predefined speed threshold (e.g., 5 miles per hour) or when the vehicle 100 may be parked (determined based on the inputs obtained from the vehicle sensory system 230 or the VCU 208). It may be appreciated that when the vehicle speed is slow, it may be easier for onlookers to view the content being displayed on the display screen 102. Therefore, in such a condition, the processor 240 may perform the predefined action(s) described above, to protect the user's privacy.

In another exemplary aspect, the processor 240 may determine that the predefined criterion associated with the vehicle surrounding condition is met when one or more onlookers or users (e.g., a user 302) are located in proximity to a portion or side of the vehicle 100 that includes the display screen 102, as shown in FIG. 3. For example, if the display screen 102 is located on a vehicle's right side and the user 302 too is located in proximity to the vehicle's right side, the processor 240 may determine that the predefined criterion associated with the vehicle surrounding condition is met and may hence perform the predefined action(s) described above, to protect the user's privacy.

In this case, the processor 240 may further determine an eye or a head trajectory of the user 302 based on the inputs obtained from the vehicle sensory system 230 and may determine that the predefined criterion associated with the vehicle surrounding condition is met when the eye or head trajectory of the user 302 aligns with the display screen 102. It may be appreciated that when the eye or head trajectory of the user 302 aligns with the display screen 102, the probability of the user 302 viewing the content on the display screen 102 may be high. Therefore, to protect the privacy of the user 108 in this case, the processor 240 may perform the predefined action(s) described above, which may prevent the user 302 from viewing the content.

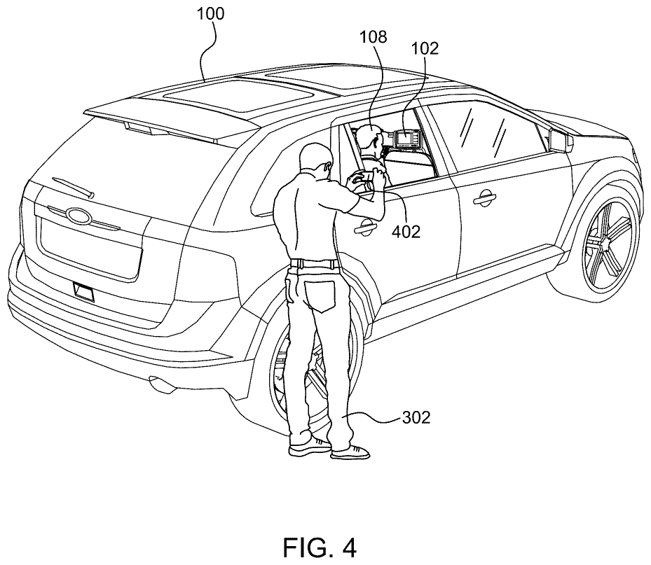

In yet another exemplary aspect, the processor 240 may determine that the predefined criterion associated with the vehicle surrounding condition is met when an onlooker (e.g., the user 302) may be having/carrying an image capturing device (shown as an image capturing device 402 in FIG. 4) whose field of view (FOV) may be aligned with the display screen 102. The image capturing device 402 may be, for example, a camera, a mobile phone, a tablet, and/or the like.

In this case, the processor 240 may first determine that the user 302 be having or carrying the image capturing device 402 based on the inputs obtained from the vehicle sensory system 230, when the user 302 may be located in proximity to the vehicle 100. The processor 240 may then check whether the image capturing device's FOV aligns with the display screen 102, based on the inputs obtained from the vehicle sensory system 230. The processor 240 may determine that the predefined criterion associated with the vehicle surrounding condition is met when the image capturing device's FOV aligns with the display screen 102.

In some aspects, the processor 240 may check whether the image capturing device's FOV aligns with the display screen 102 irrespective of whether the eye or head trajectory of the user 302 aligns with the display screen 102 or not. It may be appreciated that the user 302 may still capture the display screen's image by using the image capturing device 402, even when the user's eyes or head may be aligned away from the display screen 102. To protect the user's privacy in such cases as well, the processor 240 may perform the predefined action(s) described above when the image capturing device's FOV aligns with the display screen 102.

In yet another exemplary aspect, the processor 240 may determine that the predefined criterion associated with the vehicle surrounding condition is met when one or more additional vehicles (e.g., a second vehicle 502 shown in FIG. 5) are located in proximity to the vehicle 100 and determined based on the inputs obtained from the vehicle sensory system 230. In this case, the processor 240 may determine that the predefined criterion associated with the vehicle surrounding condition is met irrespective of whether the vehicle 100 is moving (below or above the predefined speed threshold) or is parked. It may be appreciated that even if the vehicle 100 is moving (e.g., above the predefined speed threshold described above) and if the second vehicle 502 is located/moving in proximity to the vehicle 100, the occupant(s) of the vehicle 502 may still view the display screen 102. To protect the user's privacy in such instances, the processor 240 may perform the predefined action(s) described above whenever the vehicle 502 may be located in proximity to the vehicle 100.

In this case, in some aspects, the processor 240 may determine that the predefined criterion associated with the vehicle surrounding condition is met when the vehicle 502 is located in proximity to that portion or side of the vehicle 100 that includes the display screen 102 (as shown in FIG. 5). It may be appreciated that if the display screen 102 is located on the right (or left) side of the vehicle 100 and the vehicle 502 too is located in proximity to the vehicle's right (or left) side, it may be easy for the occupants of the vehicle 502 to view the content on the display screen 102. Consequently, to protect the user's privacy in such instances, the processor 240 may perform the predefined action(s) described above.

It may be appreciated from the description above that by performing the predefined action(s) associated with the content and/or the display screen 102, the processor 240 makes it harder for the user 302 or the occupants in the vehicle 502 to view the content on the display screen 102, thereby protecting the user's privacy. Further, the vehicle 100 does not require use of any external material (e.g., shades, etc.) to hide the display screen 102, but instead uses the vehicle's existing components to protect the user's privacy. Therefore, the system and method disclosed in the present disclosure is simple to implement.

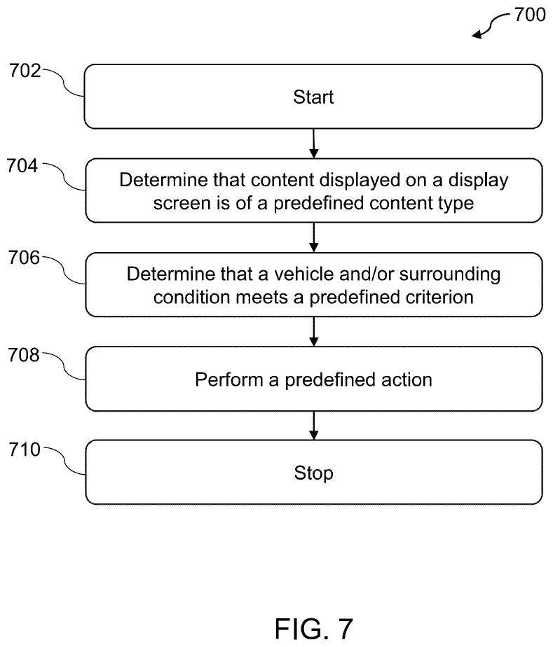

FIG. 7 depicts a flow diagram of an example method 700 to adjust a vehicle display screen (e.g., the display screen 102) in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include determining, by the processor 240, that the content being displayed on the display screen 102 is of predefined content type. At step 706, the method 700 may include determining, by the processor 240, that the vehicle condition and/or the vehicle surrounding condition meets a predefined criterion based on the inputs obtained from the vehicle sensory system 230 responsive to determining that the content is of predefined content type, as described above.

At step 708, the method 700 may include performing, by the processor 240, one or more predefined actions associated with the content and/or the display screen 102 responsive to determining that the predefined criterion is met, to protect the user's privacy. The examples of the predefined actions performed by the processor 240 are described above in conjunction with FIG. 2.

At step 710, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a display screen configured to display a content;
a sensor unit configured to detect a vehicle condition and a vehicle surrounding condition; and
a processor configured to:
determine that the content being displayed on the display screen is of a predefined content type;
determine that at least one of the vehicle condition or the vehicle surrounding condition meets a predefined criterion based on inputs obtained from the sensor unit, responsive to determining that the content is of the predefined content type; and
perform a predefined action associated with the content or the display screen responsive to determining that the predefined criterion is met.

2. The vehicle of claim 1, wherein the predefined content type comprises content associated with one or more of: a personal information, a banking or financial information, a confidential or secret information, explicit language, mature content, or private content.

3. The vehicle of claim 1, wherein the processor is further configured to:
obtain the inputs from the sensor unit;
determine that the content being displayed on the display screen comprises a predefined word or phrase based on the inputs; and
determine that the content is of the predefined content type responsive to determining that the predefined word or phrase is present in the content.

4. The vehicle of claim 3, wherein the predefined word or phrase comprises a word “Confidential”, “Secret” or “Sensitive”.

5. The vehicle of claim 1, wherein the processor determines that the vehicle condition meets the predefined criterion when a vehicle speed is less than a predefined speed threshold.

6. The vehicle of claim 1, wherein the processor determines that the vehicle surrounding condition meets the predefined criterion when one or more additional vehicles are located in proximity to the vehicle.

7. The vehicle of claim 6, wherein the processor determines that the vehicle surrounding condition meets the predefined criterion when the one or more additional vehicles are located in proximity to a portion of the vehicle comprising the display screen.

8. The vehicle of claim 1, wherein the processor determines that the vehicle surrounding condition meets the predefined criterion when one or more users are located in proximity to a portion of the vehicle comprising the display screen.

9. The vehicle of claim 8, wherein the processor is further configured to:
determine an eye or head trajectory of the one or more users based on the inputs obtained from the sensor unit;
determine that the eye or head trajectory aligns with the display screen based on the inputs obtained from the sensor unit; and
determine that the vehicle surrounding condition meets the predefined criterion when the eye or head trajectory aligns with the display screen.

10. The vehicle of claim 8, wherein the processor is further configured to:
determine that at least one user of the one or more users have an image capturing device based on the inputs obtained from the sensor unit;
determine that a field of view (FOV) of the image capturing device aligns with the display screen based on the inputs obtained from the sensor unit; and
determine that the vehicle surrounding condition meets the predefined criterion when the FOV aligns with the display screen.

11. The vehicle of claim 1, wherein the predefined action comprises one of: blanking out the display screen, stopping the content on the display screen or redacting the content on the display screen.

12. The vehicle of claim 1, wherein the predefined action comprises changing a font size or type of the content on the display screen.

13. The vehicle of claim 1, wherein the predefined action comprises changing a color or brightness of a portion of the display screen displaying the content.

14. The vehicle of claim 1, wherein the sensor unit comprises one or more of: a vehicle camera, a Radio Detection And Ranging (radar) sensor, a Light Detection and Ranging (lidar) sensor, or a blind spot monitoring unit.

15. The vehicle of claim 1, wherein the display screen is associated with a mobile office environment, a vehicle based office, or a video viewing screen.

16. A method comprising:
determining, by a processor, that a content being displayed on a display screen of a vehicle is of a predefined content type;
determining, by the processor, that at least one of a vehicle condition or a vehicle surrounding condition meets a predefined criterion based on inputs obtained from a sensor unit responsive to determining that the content is of the predefined content type, wherein the sensor unit is configured to detect the vehicle condition and the vehicle surrounding condition; and
performing, by the processor, a predefined action associated with the content or the display screen responsive to determining that the predefined criterion is met.

17. The method of claim 16 further comprising:
obtaining the inputs from the sensor unit;
determining that the content being displayed on the display screen comprises a predefined word or phrase based on the inputs; and
determining that the content is of the predefined content type responsive to determining that the predefined word or phrase is present in the content.

18. The method of claim 16 further comprising:
determining that at least one user, of one or more users located in proximity to the vehicle, have an image capturing device based on the inputs obtained from the sensor unit;
determining that a field of view (FOV) of the image capturing device aligns with the display screen based on the inputs obtained from the sensor unit; and
determining that the vehicle surrounding condition meets the predefined criterion when the FOV aligns with the display screen.

19. The method of claim 16, wherein determining that the vehicle condition meets the predefined criterion comprises determining that a vehicle speed is less than a predefined speed threshold.

20. A non-transitory computer-readable storage medium having instructions stored thereupon which, when executed by a processor, cause the processor to:
determine that a content being displayed on a display screen of a vehicle is of a predefined content type;
determine that at least one of a vehicle condition or a vehicle surrounding condition meets a predefined criterion based on inputs obtained from a sensor unit responsive to determining that the content is of the predefined content type, wherein the sensor unit is configured to detect the vehicle condition and the vehicle surrounding condition; and
perform a predefined action associated with the content or the display screen responsive to determining that the predefined criterion is met.
